(19) United States
(12) Patent Application Publication
(10) Pub. No.: US 2019/0055047 A1
(43) Pub. Date: Feb. 21, 2019

(54) BOTTLE WITH BASE

(71) Applicant: ABBOTT LABORATORIES, Abbott Park, IL (US)

(72) Inventors: Kyle DEMMINK, Columbus, OH (US); Jeremy MCBROOM, Columbus, OH (US)

(73) Assignee: ABBOTT LABORATORIES, Abbott Park, IL (US)

(21) Appl. No.: 16/079,598

(22) PCT Filed: Feb. 24, 2017
(86) PCT No.: PCT/US2017/019356

§ 371 Date: Aug. 24, 2018

Related U.S. Application Data
(60) Provisional application No. 62/299,724, filed on Feb. 25, 2016.

(51) Int. Cl. B65D 1/02; B65D 23/00; A61J 9/00

(52) U.S. Cl. CPC B65D 1/0276; A61J 2200/76; A61J 9/00; B65D 23/001

(57) ABSTRACT

A bottle (10) with an open top (12), a closed bottom (16), and a longitudinal axis extending between the open top (12) and the closed bottom (16). The bottle (10) includes a neck (20) extending from the open top (12) toward the closed bottom (16), an elongated body (22) between the neck (20) and the closed bottom (16), and a base (24). A plurality of openings (60) are defined at least in part by the base (24). The plurality of openings (60) surround the elongated body (22).

### CROSS REFERENCE TO RELATED APPLICATIONS

This application claims priority to and the benefit of U.S. Application No. 62/299,724, filed on Feb. 25, 2016, the entire contents of which are incorporated herein by reference.

### BACKGROUND

Liquids are commonly packaged in bottles, such as for example, consumable liquids in plastic bottles. A consumable liquid may be packaged in a bottle in a variety of sizes, such as a smaller single-serving bottle. Many drinks, nutritional products, and other beverages, may be prepared and packaged in an industrial environment. The shape and size of a plastic bottle is significant for several functional reasons. A plastic bottle used to package a consumable liquid which has a shape and size to allow for efficient bottling is preferred by the bottler. In addition, a bottle that includes features that aid the user in dispensing the consumable liquid is preferred by the end user.

### SUMMARY

The present application describes a bottle for use in storing a liquid, such as a nutritional liquid.

In an exemplary embodiment, a bottle includes an open top, a closed bottom, and a longitudinal axis extending between the open top and the closed bottom. The bottle includes a neck extending from the open top toward the closed bottom, an elongated body between the neck and the closed bottom, and a base. A plurality of openings surround the elongated body.

Further features and advantages of the invention will become apparent from the following detailed description made with reference to the accompanying drawings.

### BRIEF DESCRIPTION OF THE DRAWINGS

Features and advantages of the general inventive concepts will become apparent from the following detailed description made with reference to the accompanying drawings.

FIG. 1 is a top, perspective view of an exemplary embodiment of a bottle;

FIG. 2 is a bottom, perspective view of the bottle of FIG. 1;

FIG. 3 is a right side view of the bottle of FIG. 1;

FIG. 4 is a perspective, sectional view of the bottle of FIG. 1, shown along the line 4-4 of FIG. 1;

FIG. 5 is another sectional view as shown in FIG. 4, showing a front view of the bottle in an upright position;

FIG. 6 is another sectional view as shown in FIG. 4, showing a front view of the bottle in a horizontal position;

FIG. 7 is another sectional view as shown in FIG. 4, showing a front view of the bottle in a horizontal, downwardly tipped, position;

FIG. 8 is a perspective, sectional view of the bottle of FIG. 1, shown along the line 8-8 of FIG. 3;

FIG. 9 is another sectional view as shown in FIG. 8, showing a top view of the bottle in an upright position;

FIG. 10 is an enlarged view of the designated circular area of FIG. 5;

FIG. 11 is an enlarged view of the designated circular area of FIG. 10; and

FIG. 12 is an enlarged view of the designated circular area of FIG. 4.

### DETAILED DESCRIPTION

This Detailed Description merely describes exemplary embodiments in accordance with the general inventive concepts and is not intended to limit the scope of the invention or the claims in any way. Indeed, the invention as described by the claims is broader than and unlimited by the exemplary embodiments set forth herein, and the terms used in the claims have their full ordinary meaning.

The present application describes a bottle 10 for storage of a consumable liquid, such as for example, infant liquid formula. The bottle 10 may be sized as desired. For example, the bottle may be large enough for at least one serving size. Two exemplary serving sizes are 2 oz. and 60 ml, such as for example, a typical serving size for infant formula. The bottle 10 may include features to allow for efficient bottling by a bottler and to allow easier ability to aseptically sterilize the bottle interior and exterior. The bottle 10 may also include features that aid the user in dispensing the consumable liquid, such as structure that enhances gripping and manipulating the bottle and indicia to allow the user to easily determine the amount of liquid dispensed.

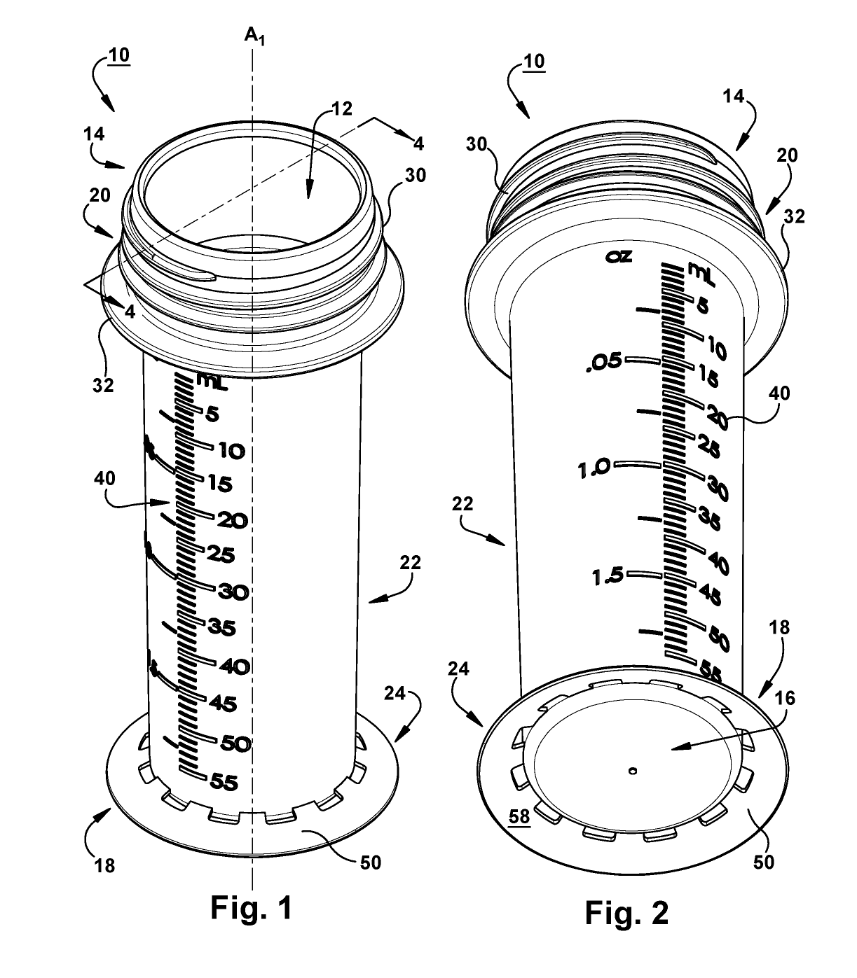

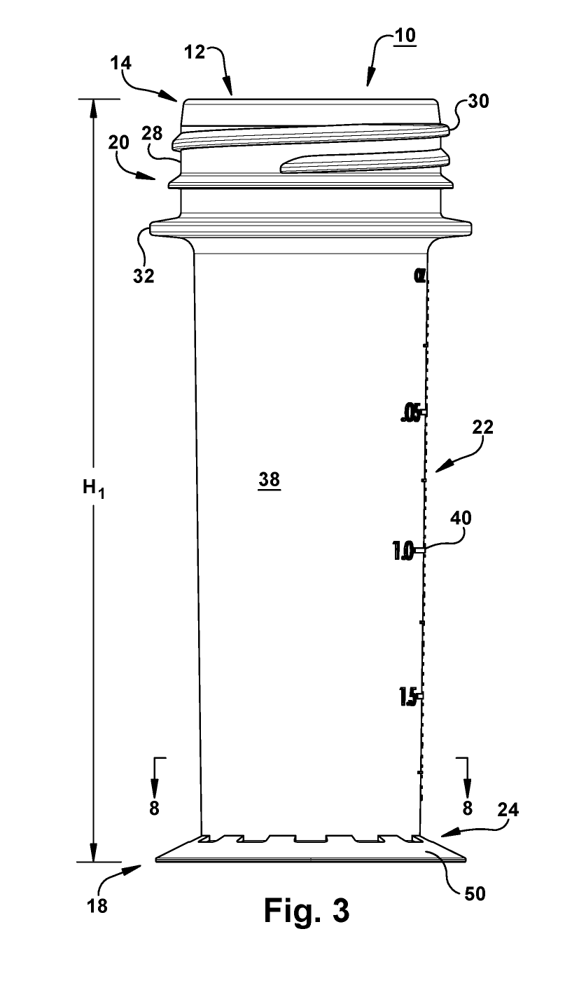

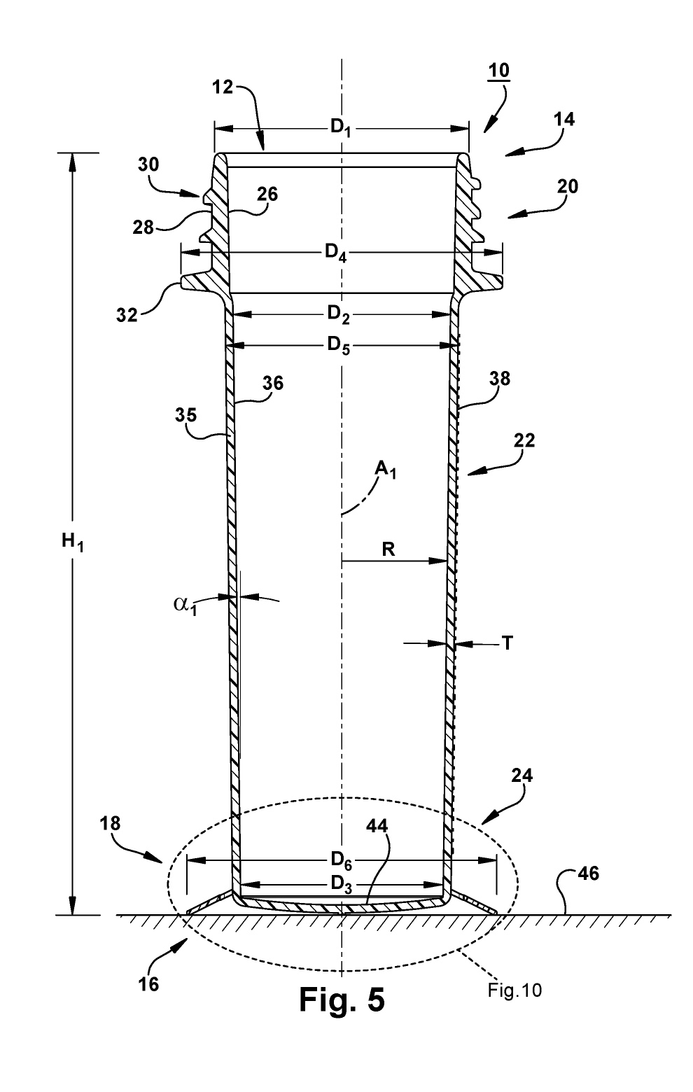

Referring to FIGS. 1-4, an exemplary embodiment of a bottle 10 is shown. The bottle 10 may be configured in a variety of ways. For example, the size of, the shape of, the material used in, and the various features of the bottle 10 may differ in different embodiments of the bottle 10. In an exemplary embodiment, the bottle 10 is generally cylindrical, has a height H₁, and includes an open top 12 at a first end 14 of the bottle 10 and a closed bottom 16 at a second end 18 of the bottle 10 opposite the first end 14. The first end 14 has an outer diameter D₁ (see FIG. 5). A central longitudinal axis A₁ extends between the open top 12 and the closed bottom 16. Portions of the bottle 10 may be symmetric about the central longitudinal axis A₁.

Referring to FIG. 5, the bottle 10 may include a neck 20, an elongated body 22, and a base 24. The neck 20 may extend from the open top 12 in a direction toward the closed bottom 16. The neck 20 may include a generally cylindrical inner surface 26 and a generally cylindrical outer surface 28. The neck 20 may include attaching structure that facilitates attaching a closure (not shown) or a nipple (not shown) onto the open top 12 of the bottle 10. In the illustrated embodiment, the attaching structure includes a threaded top section 30 adjacent the open top 12. In the illustrated embodiment, the neck 20 may also include circumferential flange 32 positioned between the closed bottom 16 and the threaded top section 30. The circumferential flange 32 has an outer or maximum diameter D₄. In the illustrated embodiment, the outer diameter D₄ of the flange 32 is greater than the outer diameter D₁ of the first end 14.

The elongated body 22 extends between the neck 20 and the closed bottom 16. The body 22 includes a wall 35 having a generally cylindrical inner surface 36 and a generally cylindrical outer surface 38. In the illustrated embodiment, the inner surface 36 of the body 22 tapers inward from adjacent the neck 20 to adjacent the closed bottom 16 such that an internal radius R of the cylindrical inner surface 36 along the central longitudinal axis A₁ reduces in a direction from the neck 20 to the base 24. Thus, the inner diameter D₂ of the body 22 adjacent the neck 20 is larger than the inner diameter D₃ of the body 22 adjacent the closed bottom 16 or base 24. In one exemplary embodiment, the inner surface 36 of the body 22 tapers inward at a substantially constant taper angle α₁. In other embodiments, however, the taper angle α₁ is not substantially constant and may vary along the longitudinal axis A₁. In one exemplary embodiment, the taper angle α₁ is in the range of 5° to 1.5°, or about 5° to about 1.5°.

In some embodiments, the generally cylindrical outer surface 38 extends between the neck 20 and the closed bottom 16 generally parallel to the inner surface 36. Thus, the wall 35 may have a generally constant thickness T. In some exemplary embodiments, the wall thickness T may be less than 0.030 inches. In some exemplary embodiments, the wall thickness T is in the range of 0.025 inches to 0.05 inches, or about 0.025 inches to about 0.05 inches. In other embodiments, however, the generally cylindrical outer surface 38 may not extend generally parallel to the inner surface 36 and the thickness T may vary along the elongated body 22. The outer surface 38 defines an outer diameter D₅ of the elongated body 22. In the exemplary embodiment, the outer diameter D₅ is largest just below the circumferential flange 32.

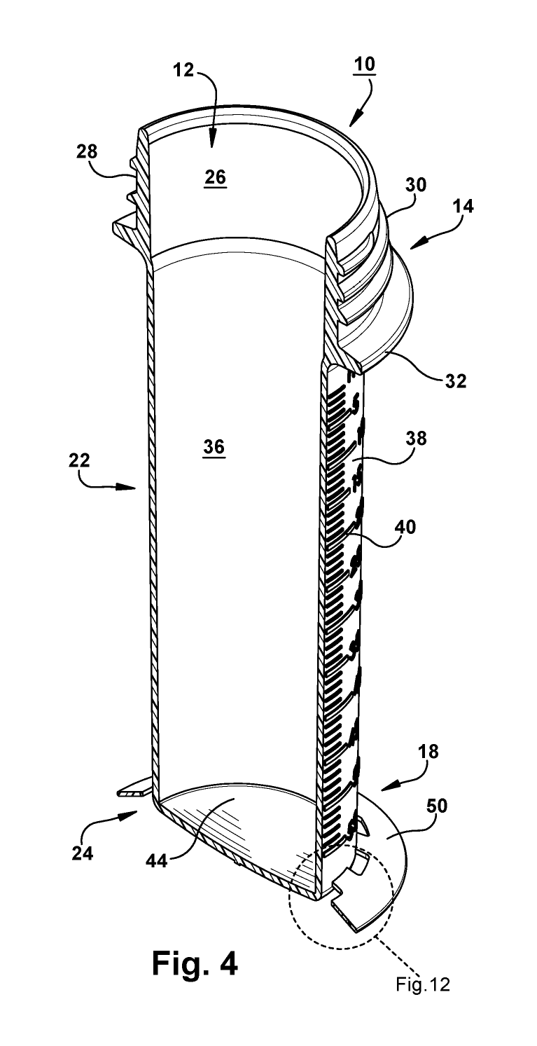

Referring to FIGS. 4 and 5, the elongated body 22 may include indicia 40 to provide an indication of the volume of liquid in the bottle 10. The indicia 40 may be configured on a variety of ways. In the illustrated embodiment, the outer surface 38 of the body 10 includes embossed, graduated markings extending from the base 24 to the neck 20, or near the base 24 to near the neck 20. The markings include numerals is descending order from near the base 24 to near the neck 20 to provide an indication of the amount of liquid consumed from the bottle 10.

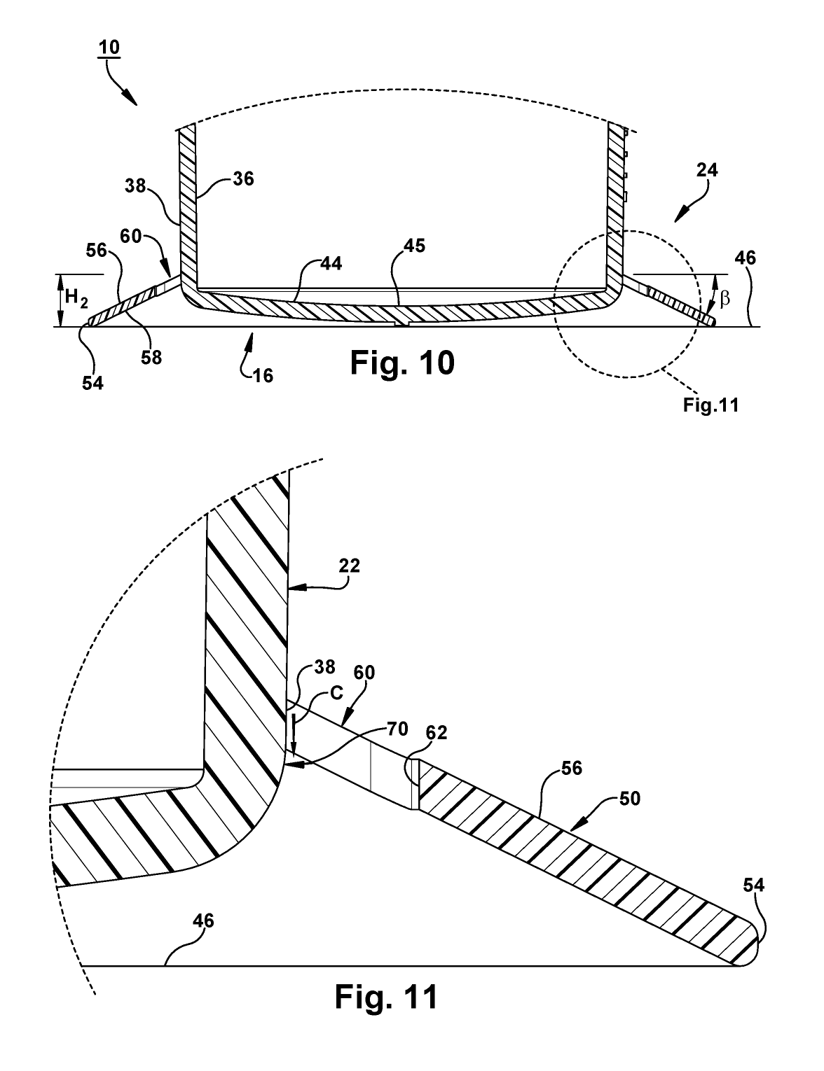

Referring to FIG. 10, the elongated body 22 may include a bottom inside surface 44 that at least partially defines the closed bottom 16. In one exemplary embodiment, the bottom inside surface 44 is concave or otherwise sunken. In one exemplary embodiment, the bottom inside surface 44 is curved to a focal point 45 to allow product and product sediment to pool toward a single point on the bottom inside surface 44. As a result, the product and product sediment may be easily extracted via a syringe, for example.

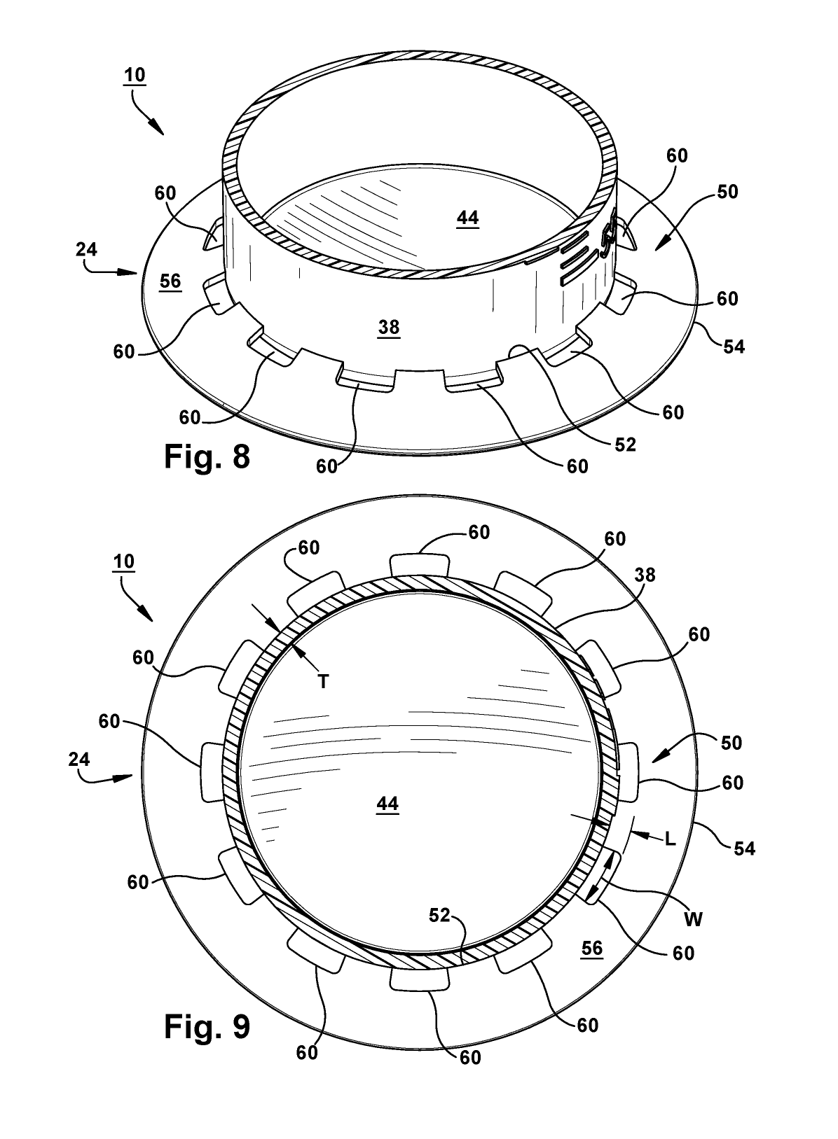

The base 24 is configure to support the bottle on a flat surface 46, such as, for example, a table or counter top. The base 24 may be configured in a variety of ways. Referring to FIGS. 8-10, in the illustrated embodiment, the base 24 is a circular-shaped pedestal base including an annular ring body 50 having an inner edge 52, an outer edge 54 opposite the inner edge 52, a top face 56 extending between the inner edge 52 to the outer edge 54, and a bottom face 58 opposite and generally parallel to the top face 56 and extending between the inner edge 52 to the outer edge 54.

The inner edge 52 is attached to the generally cylindrical outer surface 38 of the body 22 such that the top face 56 extends outward from the body 22 at a downward angle β Thus, the inner edge 52 closer to the open top 12 of the bottle 10 than the outer edge 54. In one exemplary embodiment, the angle β is in the range of 20° to 30°, or about 20° to about 30°. In other embodiments, however, the angle β may be greater than 30° or less than 20°. The inner edge 52 may be attached to the outer surface 38 of the body 22 by any suitable means. In one embodiment, the base 24 is formed integrally with the elongated body 22 and the neck 20, such as for example, by injection molding the bottle 10 as a single, integrated piece.

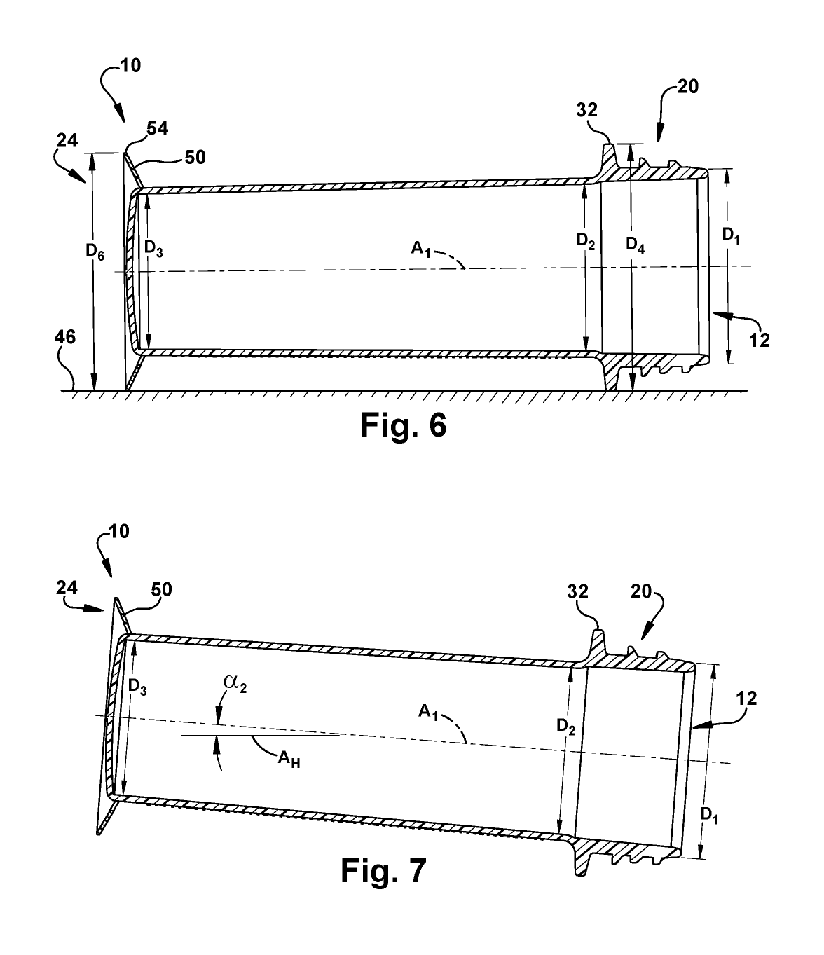

Referring to FIG. 6, the outer edge 54 defines an outer or maximum diameter D₆ of the base 24. In one exemplary embodiment, the outer diameter D₆ of the base is constant, such that the base outer edge 54 is circular. In one exemplary embodiment, the outer or maximum diameter D₆ of the base 24 is the same as the outer or maximum diameter D₄ of the neck 20 and greater than the outer or maximum diameter D₅ (FIG. 5) of the elongated body 22, such that the bottle 10 will roll in a straight line in a horizontal position. In one exemplary embodiment, the external shape and size of the circumferential flange 32 of the neck 20, which defines the maximum diameter D₄ of the neck 20, is the same as an external shape and size of the outer edge 54 of the base 24, which defines the maximum diameter D₅ of the base 24.

Referring to FIGS. 8 and 9, the bottle 10 may include one or more openings or liquid pathways 60 that improve the ability to aseptically sterilize the bottle 10. The one or more openings or liquid pathways may be configured in a variety of ways, such as for example, the number of, location of, shape of, and size of the one or more openings or liquid pathways 60 may vary is different embodiments. In illustrated exemplary embodiment, the bottle 10 includes a plurality of openings 60 that surround the elongated body 22 and permit liquid, such as for example, cleaning solution, to travel in a downward direction along the outside surface 38 of the elongated body 22 from a location above where the inner edge 52 connects to the outside surface 38 of the elongated body 22 to a location below where the inner edge 52 connects to the outside surface 38 of the elongated body 22.

In the exemplary embodiment, the bottle 10 includes twelve openings 60 equally spaced around the circumference of the elongated body 22 with each of the plurality of openings 60 being the same size and shape, or generally the same size and shape. In other embodiments however, the bottle 10 may include more or less than twelve openings 60 and the openings 60 may not be equally spaced around the circumference of the body 22. Further, one or more of the plurality of openings 60 may be shaped or sized differently than another of the plurality of openings 60.

In one exemplary embodiment, at least one of the plurality of openings 60 is at least partially defined by the elongated body 22. In another exemplary embodiment, at least one of the plurality of openings 60 is at least partially defined by the elongated body 22 and is also at least partially defined by the base 24. In the illustrated exemplary embodiment, each of the plurality of openings 60 is defined by a recess or notch in the annular body 50 that extends from the inner edge 52 radially outward toward the outside edge 54. Thus, each of the plurality of openings 60 is positioned along the inner edge 52 of the annular body 50 of the base 24 and along an outer surface 38 of the elongated body 22. Each of the plurality of openings 60 is separated from the another of the plurality of openings 60 by a bridge section of the annular body 50. In addition, each of the plurality of openings 60 is located at the same height relative to the open top 12. In other embodiments, however, one or more of the plurality of opening may be located at a different height relative to the open top 12 or at a different location relative to the inner edge 52 or the outer surface 38 than another of the plurality of openings 60.

In the illustrated exemplary embodiment, each of the plurality of openings 60 is generally arch shaped or rectangular shaped. In other embodiments, however, one or more of the plurality of openings may be other than arch shaped or rectangular shaped, such as for example, semicircular shaped, triangular shaped, or any other suitable shape.

Referring to FIG. 9, each of the plurality of openings 60 has a width W and a radial length L. The width W is defined by the arc length of each opening 60 around the annular body 50. The width W of each opening 60 is greater than the radial length L of each opening. In other embodiments, however, the width W may be less than the radial length L. In some embodiments, the width W is at least 1.5× the radial length L or at least 2× the radial length L.

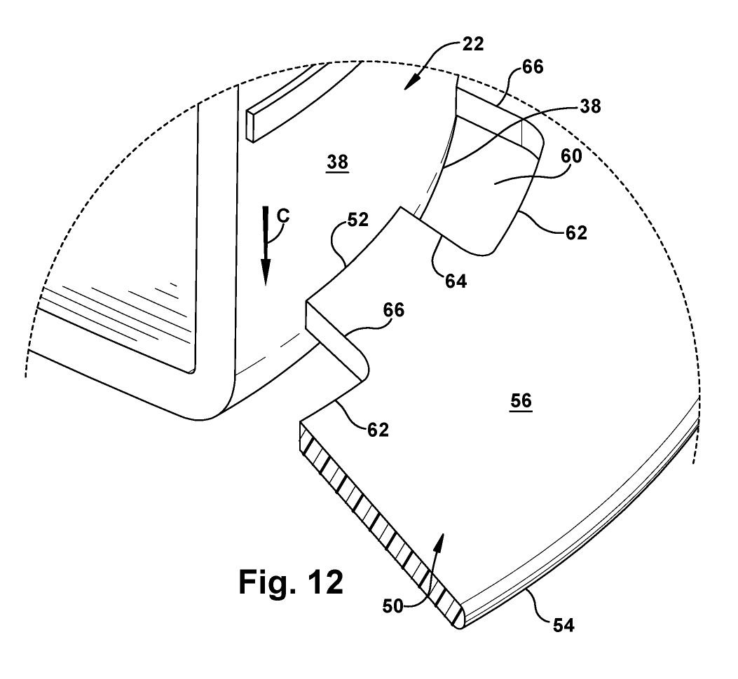

Referring to FIGS. 11 and 12, in the illustrated exemplary embodiment, each of the plurality of openings 60 is defined by the outer surface 38 of the elongated body 22, an outer edge 62 spaced apart from the outer surface 38, a first side edge 64 extending between the outer edge 62 and the outer surface 38, and a second side edge 66 spaced apart from the first side edge 64 and extending between the outer edge 62 and the outer surface 38.

The bottle 10 may be formed by any suitable manufacturing process and may be made from any suitable materials. For example, the bottle 10 can be manufactured by one of several known processes, including injection molding. The bottle 10 can be formed as a single-piece, integrated component. In other embodiments, however, the bottle 10 may include multiple portions attached together, such as for example, the annular body 50 of the base 24 may be separately formed and attached to the elongated body 22. The bottle may be formed from one or more plastics, including, but not limited to, polyethylene terephthalate (PETE), high density polyethylene (HDPE), low density polyethylene (LDPE), polyvinyl chloride (PVC), polypropylene, polysterene (PS), and polycarbonates.

In one exemplary embodiment, the bottle 10 is capable of aseptic packaging, is injection molded, has a multi-layer plastic structure, and at least one oxygen barrier layer, such as for example, ethylene vinyl alcohol (EVOH).

The bottle 10 offers certain advantageous features. For example, in one embodiment, the bottle 10 may be shaped to remain cylindrical when rotated around a vertical axis to allow for easy flow of liquid out of the bottle with less potential for liquid to remain after the bottle is emptied. In some embodiments, the inner surface 36 of the body 22 tapers inward from adjacent the neck 20 to adjacent the closed bottom such that an internal radius R of the cylindrical inner surface 36 along the central longitudinal axis A₁ reduces in a direction from the neck 20 to the base 24. As a result, as shown in FIG. 7, the bottle 10 allows for dispensing of the all of the liquid at lower inversion angle α₂ relative to a horizontal plane A_{H} (i.e., the bottle does not have to be tipped as much for the liquid to drain out).

In another embodiment, the outer or maximum diameter D₆ of the base 24 may be the same as the outer or maximum diameter D₄ of the neck 20 and greater than the outer or maximum diameter D₅ of the elongated body 22, such that the bottle 10 will roll in a straight line in a horizontal position. In another embodiment, the bottom inside surface 44 of the base 24 is curved to a focal point 45 to allow product and product sediment to pool toward a single point on the bottom inside surface 44 allowing for the product and product sediment to be easily extracted via a syringe, for example, and less surface area for product sediment to materialize on.

In another embodiment, the bottle 10 may include one or more openings or liquid pathways 60 that improve the ability to aseptically sterilize the bottle 10. For example, the one or more openings or liquid pathways 60 allow liquid on the outside surface 38 of the elongated body 22 to flow past the base 24 via the openings 60. Thus, the plurality of openings 60 permits liquid to travel from above the base 24 to a point 70 below the base, relative to the open top 12.

While various inventive aspects, concepts, and features of the general inventive concepts are described and illustrated herein in the context of various exemplary embodiments, these various aspects, concepts, and features may be used in many alternative embodiments, either individually or in various combinations thereof. Unless expressly excluded herein all such combinations are intended to be within the scope of the general inventive concepts. Still further, while various alternative embodiments as to the various aspects, concepts, and features of the inventions (such as alternative materials, structures, configurations, methods, devices and components, alternatives as to form, fit and function, and so on) may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the general inventive concepts even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure; however, such values and ranges are not to be construed in a limiting sense and are intended to be critical values or ranges only if so expressly stated. Moreover, while various aspects, features, and concepts may be expressly identified herein as being inventive or forming part of an invention, such identification is not intended to be exclusive, but rather there may be inventive aspects, concepts, and features that are fully described herein without being expressly identified as such or as part of a specific invention. Descriptions of exemplary methods or processes are not limited to inclusion of all steps as being required in all cases, nor is the order that the steps are presented to be construed as required or necessary unless expressly so stated.

What is claimed is:

1. A bottle having an open top, a closed bottom, and a longitudinal axis extending between the open top and the closed bottom, the bottle comprising:
a neck extending from the open top toward the closed bottom;
an elongated body between the neck and the closed bottom; and
a base;
wherein a plurality of openings are defined at least in part by the base, and the plurality of openings surround the elongated body.

2. The bottle of claim 1, wherein at least one of the plurality of openings permits liquid to travel along an outside surface of the elongated body and through the at least one of the plurality of openings in a downward direction toward the closed bottom.

3. The bottle of claim 1, wherein at least one of the plurality of openings permits liquid to travel along an outside surface of the elongated body from above the at least one of the plurality of openings to below the at least one of the plurality of openings.

4. The bottle of claim 1, wherein at least one of the plurality of openings is at least partially defined by the elongated body.

5. The bottle of claim 1, wherein each of the plurality of openings is at least partially defined by the elongated body and at least partially defined by the base.

6. The bottle of claim 1, wherein each of the plurality of openings is positioned along a top edge of the base and along an outer surface of the elongated body.

7. The bottle of claim 1, wherein each of the plurality of openings permits liquid to travel from above the base to below the base, relative to the open top.

8. The bottle of claim 1, wherein the maximum diameter of the neck is the same as the maximum diameter of the base and more than the maximum diameter of the elongated body.

9. The bottle of claim 8, wherein an external shape and size of the neck at the maximum diameter of the neck is the same as an external shape and size of the base at the maximum diameter of the base.

10. The bottle of claim 1, wherein the plurality of openings are equally spaced.

11. The bottle of claim 1, wherein each of the plurality of openings is the same size and shape.

12. The bottle of claim 1, wherein each of the plurality of openings is located at the same height relative to the open top.

13. The bottle of claim 1, wherein the neck comprises a threaded top section for closure or nipple attachment.

14. The bottle of claim 1, wherein a bottom inside surface of the elongated body is concave.

15. The bottle of claim 1, wherein the elongated body has embossed, graduated markings on an exterior surface.

16. The bottle of claim 1, wherein the base is a circular-shaped pedestal base.

17. The bottle of claim 16, wherein each of the plurality of openings has an arc length around the pedestal base greater than a radial length.

18. The bottle of claim 1, wherein an internal radius of the elongated body along the central longitudinal axis reduces in a direction from the neck to the base.

19. The bottle of claim 1, wherein the bottle is injection molded and constructed of multi-layer plastic having an oxygen barrier.

20. The bottle of claim 1, wherein the bottle is capable of aseptic packaging.
